(19) United States
(12) Patent Application Publication
(10) Pub. No.: US 2009/0068536 A1
(43) Pub. Date: Mar. 12, 2009

(54) OVOID SHAPED FUEL STORAGE TANK

(76) Inventors: David A. Young, Huntington Woods, MI (US); James W. Dandalides, Macomb, MI (US); Sai Diwakar, Troy, MI (US); Sheri L. Fraser, Oxford, MI (US)

Correspondence Address: FRASER CLEMENS MARTIN & MILLER LLC, 28366 KENSINGTON LANE, PERRYSBURG, OH, 43551-4163, US

(21) Appl. No.: 11/853,855

(22) Filed: Sep. 12, 2007

(51) Int. Cl. H01M 8/02; B60K 15/073

(52) U.S. Cl. 429/34; 220/669; 220/500

(57) ABSTRACT

A fuel cell powered vehicle is disclosed having a fuel storage tank, wherein the fuel tank is disposed on an undercarriage of the vehicle and has a substantially ovoid shape to militate against interference with a function of a suspension system of the vehicle.

### FIELD OF THE INVENTION

The invention relates to a fuel cell powered vehicle an more particularly to a fuel cell powered vehicle having a fuel storage tank, wherein the fuel tank is disposed on an undercarriage of the vehicle and has a substantially ovoid shape.

### BACKGROUND OF THE INVENTION

Typical fuel cell powered vehicles use fuel cell power systems that convert a fuel and an oxidant into electricity. One type of fuel cell power system employs use of a proton exchange membrane (hereinafter “PEM”) to catalytically facilitate reaction of fuels (such as hydrogen) and oxidants (such as air or oxygen) into electricity. The fuel is typically stored in large pressurized fuel tanks and stored on an undercarriage of the vehicle. Due to the large fuel tank size, interior passenger space or cargo space may be reduced to provide enough fuel to meet vehicle performance requirements. Vehicle system efficiency concerns dictate that large fuel tanks, rather than a series of small tanks, be utilized for fuel storage.

Typically, fuel tanks are cylindrical in shape, and are disposed transversely on the undercarriage of the vehicle, behind the rear passenger seats and between the wheel assemblies. Current fuel tanks are manufactured using a filament wound composite method. However, the use of the filament wound composite method restricts the shape of the fuel tank to a simple geometric shape, such as a cylindrical shape, for example.

The large size and shape of the fuel tank often restricts the function of the vehicle suspension system and limits the suspension linkage shape and suspension configuration. In a vehicle utilizing a double A-arm type suspension system, the corners of a cylindrical fuel tank interfere with the suspension system.

It would be desirable to develop a fuel storage tank for a fuel cell powered vehicle with an improved design adapted to maximize interior passenger space, cargo space, and fuel storage capacity, while minimizing interference a suspension system of the vehicle.

### SUMMARY OF THE INVENTION

Concordant and congruous with the present invention, a fuel tank for a fuel cell powered vehicle with an improved design adapted to maximize interior passenger space, cargo space, and fuel storage capacity, while minimizing interference with the suspension system of the vehicle, has surprisingly been discovered.

In one embodiment, the fuel tank comprises an outer wall forming a cavity for housing a compressed fuel; a first portion having a first volume; a second portion having a second volume substantially equal to the first volume; and a third portion disposed between said first portion and said second portion and having a volume greater than the volume of each of said first portion and said second portion, the fuel tank adapted to be disposed on an undercarriage of a fuel cell powered vehicle and minimize an interference with a suspension system of the vehicle.

In another embodiment, the fuel tank comprises a substantially ovoid shaped outer wall, said outer wall forming a cavity for housing a compressed fuel, the fuel tank adapted to be disposed on a fuel cell powered vehicle and minimize an interference with a suspension system of the vehicle.

In another embodiment, the fuel cell propulsion system comprises a fuel cell system, including a stack which includes a plurality of fuel cell plates; and a fuel tank having an outer wall forming a cavity for housing a compressed fuel, the outer wall having a first portion having a first volume, a second portion having a second volume substantially equal to the first volume, and a third portion disposed between said first portion and said second portion and having a volume greater than the volume of each of said first portion and said second portion, the fuel tank adapted to be disposed on an undercarriage of a fuel cell powered vehicle and minimize an interference with a suspension system of the vehicle.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic rear view of a vehicle incorporating a suspension system and a fuel tank as known in the art;

FIG. 2 is a schematic rear view of a vehicle and a first suspension system incorporating a fuel tank according to an embodiment of the invention;

FIG. 3, is a perspective view of the fuel tank of FIG. 2 having a substantially rectangular cross-sectional shape;

FIG. 4 is a schematic rear view of a vehicle and a second suspension system incorporating the fuel tank illustrated in FIG. 2; and

FIG. 5 is a schematic rear view of a vehicle and suspension system incorporating a fuel tank according to another embodiment of the invention.

FIG. 6 is a perspective view of the fuel tank of FIG. 5 having a substantially circular cross-sectional shape.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

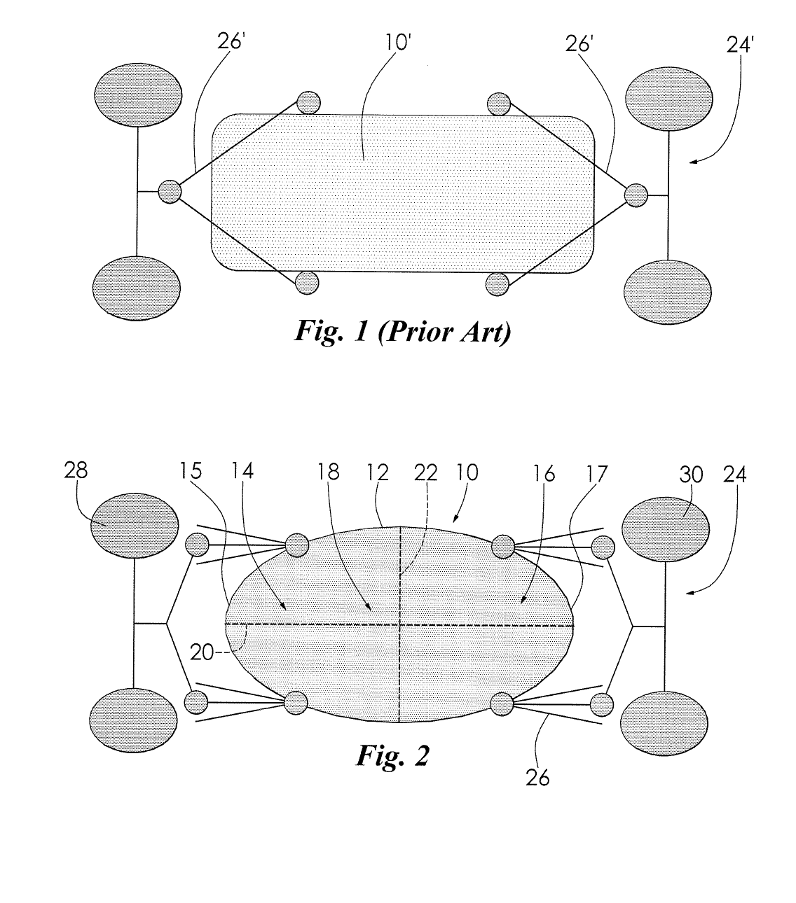

FIG. 1 illustrates a vehicle 24′ with a fuel tank 10′ according to the prior art. The fuel tank 10′ has a substantially cylindrical shape. As shown, the cylindrical shape of the fuel tank 10′ intersects the fuel tank 10′ and interferes with a suspension system 26′ of the vehicle 24′. The shape of the fuel tank 10′ also limits a movement of components of the suspension system 26′ such as a linkage (not shown), for example. A configuration of the suspension system 26′ is also restricted.

FIG. 2 shows a fuel tank 10 according to an embodiment of the invention. The fuel tank 10 includes an outer wall 12, a first portion 14, a second portion 16, and a third portion 18. Typically, the fuel tank 10 depends from an undercarriage (not shown) of a fuel cell powered vehicle 24. It is understood that the fuel tank 10 may be disposed on any vehicle and on any portion of the vehicle, as desired.

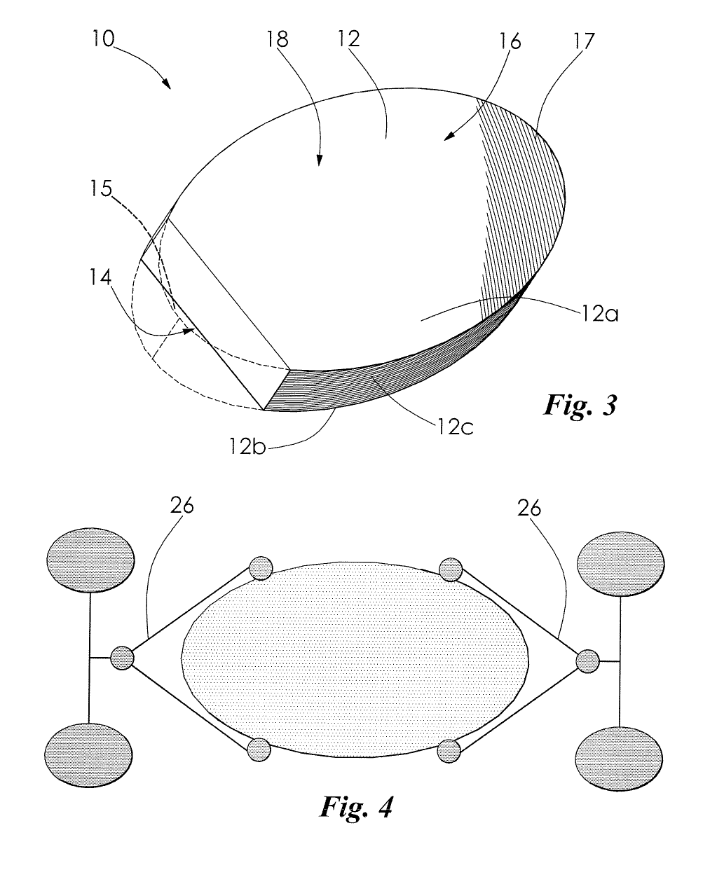

The outer wall 12 has a length 20 and a width 22 and forms a cavity adapted to house a fuel (not shown). In the embodiment shown, the length 20 of the outer wall 12 of the fuel tank 10 is greater than the width 22, and the first portion 14 and the second portion 16 have a substantially rounded first end 15 and second end 17, respectively. Therefore, the outer wall 12 has a substantially ovoid or football shape. It is understood that the outer wall 12 may have any shape with the length 20 greater than the width 22, as desired. As shown in FIG. 3, the outer wall 12 has a substantially flat top 12a, a substantially flat bottom 12b, and substantially flat sides 12c to form a substantially rectangular cross-sectional shape. It is understood that the top 12a, bottom 12b, and sides 12c may have any configuration to form a substantially circular cross-sectional shape, a substantially triangular cross-sectional shape, a substantially ovoid cross-sectional shape, and other cross-sectional shape, as desired. It is further understood that the outer wall 12 may be formed from any conventional material with mechanical properties sufficient to house a compressed fuel. The outer wall 12 may be formed from a metal, a plastic, a composite material, and any other conventional material capable of withstanding high fluid pressures, as desired. The fuel may be a liquid or a compressed gas, such as hydrogen, for example.

The first portion 14 of the fuel tank 10 is formed adjacent the first end 15 of the fuel tank 10 and is disposed adjacent the wheel assembly 28 of the vehicle 24. A suspension system 26 of the vehicle 24 is disposed around the first portion 14 of the fuel tank 10. As shown in FIG. 2, the suspension system 26 is a double-A arm suspension system. It is understood that the first portion 14 may have any volume, as desired. It is further understood that the suspension system 26 may be any conventional suspension system 26 such as double A-arm shown in FIG. 4, multi-link, and leaf and beam, for example.

The second portion 16 of the fuel tank 10 is formed adjacent the second end 17 of the fuel tank 10 and is disposed adjacent the wheel assembly 30 of the vehicle 24. The suspension system 26 of the vehicle 24 is disposed around the second portion 16 of the fuel tank 10. The volume of the second portion 16 is substantially equal to the volume of the first portion 14. It is understood that the second portion 16 may have any volume, as desired.

The third portion 18 of the fuel tank 10 is formed intermediate the first portion 14 and the second portion 16 of the fuel tank 10. The volume of the third portion 18 is greater than the volume of each of the first portion 14 and the second portion 16.

In use, the fuel tank 10 is in fluid communication with a fuel cell system (not shown). When the vehicle 24 is in operation, the fuel tank 10 provides a feed of a fuel such as hydrogen to the anode side of the fuel cell assembly. Concurrently, a stream of an oxidant such as oxygen is fed into the cathode side of the fuel cell system. On the anode side, the hydrogen in the hydrogen stream is catalytically split into protons and electrons. In a polymer electrolyte membrane fuel cell, the protons permeate through the membrane to the cathode side. The electrons travel along an external load circuit to the cathode side creating the current of electricity in the fuel cell assembly. On the cathode side, the oxygen in the oxidant stream reacts with the protons permeating through the membrane and the electrons from the external circuit to form water molecules.

Interference with the performance of the suspension system 26 by the fuel tank 10 during use of the vehicle 24 is minimized due to the substantially ovoid shape of the fuel tank 10. The substantially ovoid shape of the fuel tank 10 minimizes the interference with the suspension system 26 by positioning the first portion 14 and the second portion 16 within the confines of the suspension system 26, without crossing or contacting the suspension system 26. To compensate for the volume of the fuel tank 10 lost due to the shape of the first portion 14 and the second portion 16, the width 22 of the fuel tank 10 is maximized in the third portion 18, yielding a third portion 18 with a volume greater than the volumes of each of the first portion 14 and the second portion 16. By maximizing the volume of the third portion 18, the storage volume of the fuel tank 10 is maximized to provide a sufficient amount of fuel to the vehicle 24 to meet driving range requirements. A further advantage of providing a fuel tank 10 which minimizes interference with the suspension system 26 is that the interior and cargo space of the vehicle 24 required to be removed to provide for the suspension system 26 and fuel tank 10 is minimized, thereby maximizing optimum vehicle 24 utility and comfort.

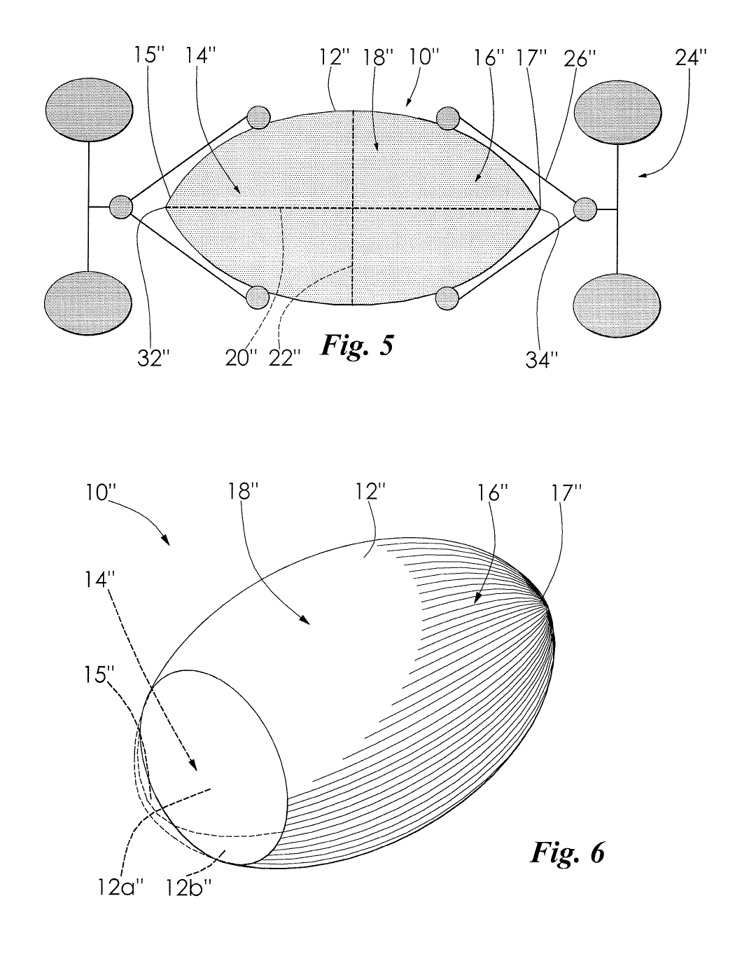

FIG. 5 shows a fuel tank 10″ according to a second embodiment of the invention. The fuel tank 10″ is similar to the fuel tank 10 shown in FIG. 2 except that the outer wall 12″ of the fuel tank 10″ at the first end 15″ and the second end 17″ has a frustoconical portion 32″ on the first portion 14″ and a frustoconical portion 34″ on the second portion 16″. As shown in FIG. 6, the outer wall 12″ has a substantially rounded top 12a″ and a substantially rounded bottom 12b″ to form a substantially circular cross-sectional shape. It is understood that the top 12a″ and the bottom 12b″ may have any configuration to form a substantially circular cross-sectional shape, a substantially triangular cross-sectional shape, a substantially ovoid cross-sectional shape, and other cross-sectional shape, as desired. The remaining structure, use, and advantages are substantially the same as described above for FIGS. 2, 3, and 4.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fuel tank comprising:
an outer wall forming a cavity for housing a compressed fuel;
a first portion having a first volume;
a second portion having a second volume substantially equal to the first volume; and
a third portion disposed between said first portion and said second portion and having a volume greater than the volume of each of said first portion and said second portion, the fuel tank adapted to be disposed on an undercarriage of a fuel cell powered vehicle and minimize an interference with a suspension system of the vehicle.

2. The fuel tank of claim 1, wherein said outer wall has a substantially ovoid shape.

3. The fuel tank of claim 2, wherein said outer wall has one of pointed ends and rounded ends.

4. The fuel tank of claim 1, wherein the fuel is a liquid.

5. The fuel tank of claim 1, wherein the compressed fuel is a compressed gas.

6. The fuel tank of claim 1, wherein the compressed fuel is hydrogen.

7. The fuel tank of claim 1, wherein the outer wall is formed from one of a plastic, a composite, and a metal.

8. A fuel tank comprising:
a substantially ovoid shaped outer wall, said outer wall forming a cavity for housing a compressed fuel, the fuel tank adapted to be disposed on a fuel cell powered vehicle and minimize an interference with a suspension system of the vehicle.

9. The fuel tank of claim 8, wherein the outer wall has a substantially ovoid cross-sectional shape with one of a rounded and a pointed end.

10. The fuel tank of claim 9, wherein said outer wall has one of pointed ends and rounded ends.

11. The fuel tank of claim 8, wherein the fuel is a liquid.

12. The fuel tank of claim 8, wherein the compressed fuel is a compressed gas.

13. The fuel tank of claim 8, wherein the compressed fuel is hydrogen.

14. The fuel tank of claim 8, wherein the outer wall is formed from one of a plastic, a composite, and a metal.

15. A fuel cell propulsion system comprising:
Fuel cell system, including a stack which includes a plurality of fuel cell plates; and
a fuel tank having an outer wall forming a cavity for housing a compressed fuel, the outer wall having a first portion having a first volume, a second portion having a second volume substantially equal to the first volume, and a third portion disposed between said first portion and said second portion and having a volume greater than the volume of each of said first portion and said second portion, the fuel tank adapted to be disposed on an undercarriage of a fuel cell powered vehicle and minimize an interference with a suspension system of the vehicle.

16. The fuel cell propulsion system of claim 15, wherein the outer wall has a substantially ovoid cross-sectional shape having rounded ends.

17. The fuel cell propulsion system of claim 16, wherein said outer wall has one of pointed ends and rounded ends.

18. The fuel cell propulsion system of claim 15, wherein the outer wall has a substantially ovoid cross-sectional shape having pointed ends.

19. The fuel cell propulsion system of claim 15, wherein the fuel is a liquid.

20. The fuel cell propulsion system of claim 15, wherein the outer wall is formed from one of a plastic, a composite, and a metal.
